(19) United States
(12) Patent Application Publication
(10) Pub. No.: US 2023/0136773 A1
(43) Pub. Date: May 4, 2023

(54) Driver Assistance System for a Motor Vehicle

(71) Applicant: Bayerische Motoren Werke Aktiengesellschaft, Muenchen (DE)

(72) Inventor: Steven ZOLKER, Muenchen (DE)

(21) Appl. No.: 17/910,477

(22) PCT Filed: Mar. 5, 2021
(86) PCT No.: PCT/EP2021/055663

§ 371 Date: Sep. 9, 2022

(30) Foreign Application Priority Data
Mar. 9, 2020 (DE) 10 2020 106 378.4

(51) Int. Cl. B60K 31/00; B60T 7/22; B60T 8/17; B60T 7/08

(52) U.S. Cl. CPC B60K 31/0058; B60T 7/22; B60T 8/17; B60T 7/08; B60K 31/0008; B60T 2201/02; B60T 2250/04; B60T 2210/10; B60T 2210/32; B60K 2031/0016; B60K 2031/0025

(57) ABSTRACT

A driver assistance system for automated longitudinal guidance of a motor vehicle includes a sensor system configured to identify an upcoming traffic scene, including locating road users situated ahead of the motor vehicle; and a control unit. The control unit is configured to carry out an automated longitudinal guidance of the motor vehicle depending on the upcoming traffic scene such that, in response to detecting that the upcoming traffic scene is a following-travel standstill situation, the motor vehicle is braked to a standstill at a target stopping distance from a road user situated ahead and identified as a target object. The control unit is also configured to detect a manual request to reduce the predefined target stopping distance. The control unit is further configured to reduce the target stopping distance to a reduced target stopping distance on the basis of the request.

### CROSS REFERENCE TO RELATED APPLICATION

This application is a 371 of International Application No. PCT/EP2021/055663, filed Mar. 5, 2021 which claims priority under 35 U.S.C. § 119 from German Patent Application No. 10 2020 106 378.4, filed Mar. 9, 2020, the entire disclosure of which is herein expressly incorporated by reference.

### BACKGROUND AND SUMMARY OF THE INVENTION

The invention relates to a driver assistance system and to a correspondingly designed method for automated longitudinal guidance of a motor vehicle.

Motor vehicles with longitudinal control systems or cruise control systems have been known for a long time. Most currently available cruise control systems control the speed of the motor vehicle to a predefined desired or target speed. In addition to these longitudinal control systems, nowadays it is also already possible to acquire longitudinal control systems which have added distance control, so-called adaptive longitudinal control systems or cruise control systems. Such systems which are offered, for example, under the designation “active cruise control” by the applicant of the present patent application make it possible to automatically drive the motor vehicle at a desired or a correspondingly lower speed while maintaining a desired distance from a vehicle traveling in front. In principle, the generally known longitudinal control or cruise control that maintains a particular predefined speed in this case has an additional distance function added so that the use of such “active” speed control is also possible in heavy freeway traffic and highway traffic. This so-called “active cruise control” maintains the predefined desired or target speed when the vehicle's own lane is free. If a distance sensor system that is mounted on the motor vehicle and that can operate, in particular, on a radar and/or camera basis detects a target object or (motor) vehicle traveling in front in its own lane, its own speed is adapted—for example by bringing about a suitable braking torque—to the speed of the motor vehicle traveling in front in such a way that a distance control system contained in the “active cruise control” or in the corresponding longitudinal control system automatically maintains a situation-appropriate distance, or to be more precise a predefined time interval, with respect to the motor vehicle or target object traveling in front. Such distance-controlled longitudinal control systems can nowadays control up to a standstill, wherein, during a following-travel standstill situation, the motor vehicle is braked to a standstill at a predefined—generally constant—target stopping distance from the target object. Such systems may also be part of partly automated or fully automated driving functions.

As an alternative to such cruise control systems, pure distance control systems are also known, these being designed to brake the motor vehicle when required in automated fashion to a predefined target stopping distance from a target object.

DE 10 2012 213 815 DE already discloses a cruise control system and a corresponding method that makes it possible to control the speed or the acceleration to a standstill and from standstill in what is known as stop-and-go mode. In this case, the distance from a defined target object and the actual speed are detected and evaluated so that the distance from the target object is controlled when the speed is greater than a predefined limit value. If the speed is lower, the motor vehicle is stopped by the brake control device, wherein a target route after which the motor vehicle should be stationary is predefined automatically depending on the current environment according to the detected distance. The target route can in this case be adjusted for example depending on the current driving situation (for example heavy traffic in the city center), such that a different stopping distance from the target object results.

DE 10 2014 201 105 A1 also discloses a longitudinal control system for a motor vehicle, wherein the minimum distance to be maintained from a target object traveling in front or a stationary target object is predefined depending on a determined defined object class of the target object.

Since the set stopping distance from the person in front is subjectively perceived to be different in magnitude, it is the object of the invention to provide an improved driver assistance system for automated longitudinal guidance of a motor vehicle by way of which a desired adjustment of the stopping distance from the target object can be achieved in a simple and comfortable manner despite observing all safety requirements.

This object is achieved according to the invention by way of a driver assistance system and a correspondingly designed method, as described herein.

The basis of the device according to the invention is a driver assistance system for automated longitudinal guidance of a motor vehicle, having a sensor system for identifying an upcoming traffic scene, in particular for locating road users situated up ahead, and having a control unit for automated longitudinal guidance of the motor vehicle depending on the upcoming traffic scene. In the event that a following-travel standstill situation, that is to say a following-travel situation with relevant road users (=target object) situated up ahead, is detected, the motor vehicle is braked to a standstill at a predefined target stopping distance from the road user situated up ahead and identified as a target object.

The invention is based on the knowledge that the controlled stopping distance that corresponds to the predefined target stopping distance is perceived by the driver as too great in certain traffic situations, in particular in city traffic, and the driver overdrives the automated longitudinal guidance by actuating the accelerator pedal in order to thus reduce the stopping distance. If the stopping distance desired by the driver is reached, he removes his foot from the accelerator pedal, as a result of which—depending on the configuration of the system—either the driver assistance system has to be reactivated manually or the longitudinal control changes automatically from standby mode back to “active mode”. In the case of an automatic change to the “active mode”, there may be a strong vehicle reaction (braking) that may possibly be perceived as uncomfortable after the accelerator pedal is released since the driver assistance system would like to bring the vehicle to a standstill as quickly as possible after the accelerator pedal is released due to the target stopping distance being undershot.

In order to further improve the comfort of the automated longitudinal control system, taking into account the above knowledge, the driver assistance system according to the invention is designed, during a following-travel standstill situation when the motor vehicle is at a standstill, to detect a manual request to reduce the stopping distance from the target object and to reduce the predefined target stopping distance to a reduced target stopping distance on the basis of the request. In other words, the predefined target stopping distance that is generally constant in conventional systems is adjusted to a reduced target stopping distance when it has been identified that the driver requests to reduce the current stopping distance until the vehicle has been braked to a standstill due to the automated longitudinal control when a target object is present at the predefined target stopping distance from the target object.

The control unit of the driver assistance system according to the invention is advantageously also designed, on the basis of the reduced target stopping distance, to automatically prompt a reduction in the stopping distance of the motor vehicle from the road user situated up ahead to the reduced target stopping distance (during a following-travel standstill situation), that is to say to reduce the current stopping distance from the road user situated up ahead. It is thus no longer necessary to overdrive the driver assistance system since the system itself takes on the task of “advancing” in response to a corresponding request from the driver.

Since advancing is generally desired by the driver only in particular driving situations, a further advantageous configuration of the invention makes provision for the driver assistance system to be designed to cancel the reduction of the target stopping distance when a predefined cancel condition is satisfied. The reduction can be canceled for example when the speed of the motor vehicle exceeds a predefined speed threshold, when the road currently traveled on changes, when the road type of the road currently traveled on changes, when the target object changes, when the current driving mode is left and/or when the driver assistance system is deactivated.

There are various options for manually requesting a reduction in the stopping distance. Depending on the configuration of the vehicle, the reduction can be carried out by means of speech, gestures or via an operating element—designed for example as a push element and/or rotary element. The driver assistance system advantageously comprises an operating element for manually requesting a reduction in the stopping distance, upon actuation of which operating element, during a following-travel standstill situation when the motor vehicle is at a standstill, a manual request to reduce the stopping distance is detected.

In order to prevent a further increase in the number of operating elements in the vehicle, provision may advantageously be made for the operating element for manually requesting a reduction in the stopping distance to be designed in such a way that the operating element is designed to request at least two different functionalities. The control device can identify the type of request or assign the request to one of the possible functionalities depending on the time of the actuation and/or the type of actuation. For example, it is possible to provide an operating element, upon actuation of which in regular control operation of the assistance system, that is to say outside of the following-travel standstill situation (at a standstill), the target speed or the control distance in following travel is adjusted or the driver assistance system is switched to a standby mode or deactivation mode, and upon actuation of which, during a following-travel standstill situation, a manual request to reduce the target stopping distance is identified at a standstill.

As an alternative or in addition, provision may be made in accordance the invention for the operating element (four requesting a reduction in the target stopping distance) to be configured to be actuated in at least two different types of actuation for manually requesting a reduction in the stopping distance, wherein, upon manual actuation in accordance with a first type of actuation, during a following-travel standstill situation when the motor vehicle is at a standstill, the target stopping distance is reduced by a predefined reduction distance. Upon actuation of the operating element in accordance with a second type of actuation, during a following-travel standstill situation when the motor vehicle is at a standstill, provision may be made for the target stopping distance to be continuously reduced over the duration of the actuation of the operating element in accordance with the second type of actuation, that is to say for the target stopping distance to be further reduced continuously until the driver releases the operating element. In order to provide the driver with feedback as to how great the current target stopping distance is or how great the reduction is, it is possible to provide an appropriate display. As an alternative, provision may be made for the vehicle to be advanced to the respectively applicable reduced target stopping distance continuously with the continuous reduction of the target stopping distance. As a result, the driver receives direct feedback and can release the operating element when the desired stopping distance is set.

In order to reduce the target stopping distance in a way that is suitable and able to be reproduced by the driver, the driver assistance system can advantageously be designed, given a manually requested reduction in the stopping distance, during a following-travel standstill situation when the vehicle is a standstill, to influence the extent of the reduction in the target stopping distance by at least one other detectable parameter. Provision may be made in particular for the extent of the reduction to be influence depending on a currently set driving mode, a road class of the road currently being traveled on and/or an object class of the road user situated up ahead.

Provision can also furthermore be made for the predefined target stopping distance to be reduced to a reduced target stopping distance on the basis of the request to reduce the stopping distance only when further requirements are met. For example, if the target stopping distance is already very low or if it is identified that the driver is not paying attention, a requested reduction in the target stopping distance can be suppressed. Further requirements may also be a selected driving mode, the current traffic situation or the like.

Analogously to the driver assistance system according to the invention, the invention comprises a method for automated longitudinal guidance of a motor vehicle, comprising the following steps:
identifying an upcoming traffic scene, in particular locating road users situated up ahead,
automated longitudinal guidance of the motor vehicle depending on the upcoming traffic scene, wherein, in the event that a following-travel standstill situation is detected, the motor vehicle is braked to a standstill at a predefined target stopping distance from a road user situated up ahead and identified as a target object,
detecting a manual request to reduce the stopping distance from the target object during a following-travel standstill situation when the motor vehicle is at a standstill, and
reducing the predefined target stopping distance to a reduced target stopping distance on the basis of the manual request to reduce the stopping distance.

The preferred embodiments presented with regard to the driver assistance system according to the invention and the advantages of these embodiments apply correspondingly for the method according to the invention.

The features of the invention will become apparent from the claims, the figures and the description of the figures. The features and combinations of features mentioned in the description above and the features and combinations of features mentioned in the description of the figures below and/or shown in the figures alone may be used not only in the respectively specified combination but also in other combinations or individually.

### BRIEF DESCRIPTION OF THE DRAWINGS

FIG. 1 shows a highly simplified construction of a driver assistance system serving as an example of at least one embodiment of the invention, and

FIG. 2 shows a possible configuration of a method according to at least one embodiment of the invention.

### DETAILED DESCRIPTION OF THE DRAWINGS

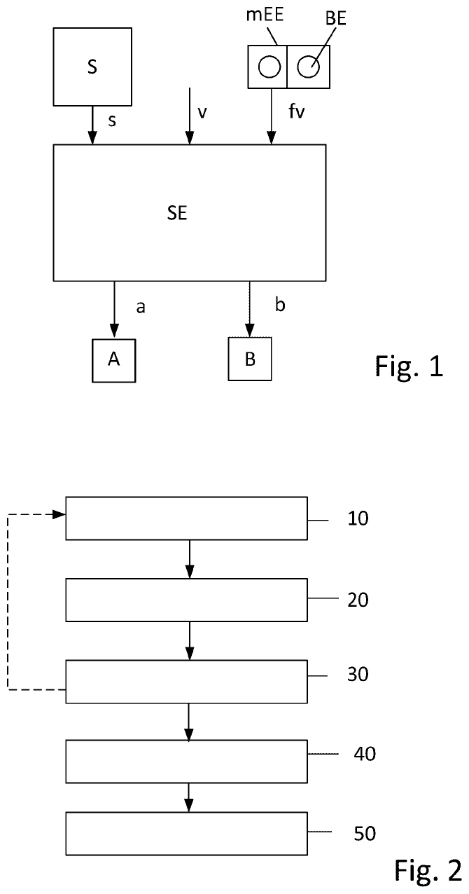

FIG. 1 shows a control unit SE as the central element of a driver assistance system for automated longitudinal guidance of a motor vehicle. In principle, the control unit SE is configured in such a way that, depending on the signals s of an environment detection sensor system S, the current speed v and the driver specifications fv (for example target speed) predefined by the driver by means of a manual input unit mEE, it transmits an acceleration signal a to a drive actuator system A and a deceleration signal b to a brake actuator system B in order to implement the driver specifications fv. The environment detection sensor system S is in this case configured in such a way that the upcoming traffic scene can be identified by means of a radar system and/or a camera system and thus in particular relevant traffic users situated up ahead can be identified.

The control unit SE is also designed to prompt braking of the motor vehicle at a predefined target braking distance from a road user situated up ahead and identified as a target object when a following-travel standstill situation, that is to say a traffic situation in which the motor vehicle provided with the driver assistance system has to be braked to a standstill on account of a road user situated up ahead, is detected.

The manual input unit mEE is designed, upon corresponding actuation of an operating element BE provided therefor, to request a reduction in the stopping distance from the target object as driver specification fv during a following-travel standstill situation when the motor vehicle is at a standstill. In this example, provision is made for the request fv to reduce the stopping distance to be able to take place in various modes. If there is a simple key press on the operating element BE provided therefor during a following-travel standstill situation when the motor vehicle is a standstill, this is evaluated as a request fv to reduce the stopping distance by a predefined extent or by a predefined reduction distance. If, instead of a simple key press, the operating element BE provided therefor is permanently actuated during a following-travel standstill situation when the motor vehicle is at a standstill, this is evaluated as a request fv to continuously reduce the stopping distance (until the operating element is released).

If the control unit SE detects a request fv to reduce the stopping distance, the control unit SE first prompts a reduction in the target stopping distance—depending on the type of request (simple key press or permanent actuation). On the basis of the reduced target stopping distance, the control unit SE then prompts a reduction in the current stopping distance to the now reduced target stopping distance by transmitting corresponding acceleration and/or braking signals a and b. If the reduction is prompted on the basis of a permanent actuation, the target stopping distance is reduced and the stopping distance associated therewith is respectively reduced to the new target stopping distance until the operating element BE is released. While the operating element BE is permanently actuated, the speed of the motor vehicle is decreased depending on the current distance as part of the reduction in the stopping distance to the new (continuously further reducing) target stopping distance. When a predefined minimum distance is reached, the vehicle stops depending on other requests.

A specific configuration of a possible configuration of the method according to the invention for automated longitudinal guidance of a motor vehicle, in particular for adjusting the stopping distance on the basis of a manual request by the driver, is now presented on the basis of the following description in relation to FIG. 2, wherein it is assumed that the control unit SE that is essential for reducing the stopping distance is accordingly designed to detect relevant input signals, to process these, to adjust the target stopping distance and to output an acceleration signal a and/or a braking signal b, determined in accordance with the adjusted target stopping distance, to the actuator system A and B for the purpose of speed control.

The flow chart starts in step 10 as soon as the driver assistance system designed as an adaptive cruise control system is switched on and active. When the cruise control system is active, in the next step 20, the upcoming traffic scene is determined on the basis of the present data of an environment detection system. In particular, traffic objects situated up ahead that are to be taken into account in the cruise control are located. If a relevant traffic object situated up ahead is detected, automatic longitudinal guidance of the motor vehicle takes place depending on the upcoming relevant traffic object. If a following-travel standstill situation, that is to say a situation in which it is necessary to brake the vehicle to a standstill on account of the traffic object situated up ahead, is detected, the motor vehicle is braked to a standstill at a predefined target braking distance from the traffic object situated up ahead and identified as target object, and the method passes to step 30 upon the standstill being reached.

As long as the method is at step 30, that is to say automatic start-up or continuation of driving is not possible, a check is continuously carried out to determine whether a reduction in the stopping distance from the target object is manually requested by the driver (for example by way of actuating an operating element provided therefor) during the following-travel standstill situation at a standstill. If no such request is detected, step 30 is left and there is a return to step 10.

However, if such a manual request is detected, in the next step 40, the current target stopping distance is reduced by a predetermined—possibly variable—extent if there are no restraint conditions (for example minimum permitted target distance already set) on the basis of the manual request to reduce the stopping distance. The extent of the reduction can be specified in this case for example depending on the type of request by the driver, the road class of the road currently traveled on, the vehicle object class of the target object, a selected driving mode (sport, comfort, eco), the location of the road, the number of lanes and/or the lane width.

If the target stopping distance has been reduced, there is a change to step 50 in which a reduction in the stopping distance of the motor vehicle from the road user situated up ahead to the reduced target stopping distance is prompted on the basis of the reduced target stopping distance. In this case, the acceleration specification and/or the deceleration specification can be carried out in order to achieve or adjust the reduced target stopping distance according to a control strategy stored for this purpose. In this case, the control strategy may be able to be influenced in turn depending on other parameters, such that the vehicle is advanced in a comfortable and replicable manner.

A system of this kind is used to provide the driver with the opportunity to enable simple and comfortable automated advancement to a road user situated up ahead, without overdriving the active driving function.

1-9. (canceled)

10. A driver assistance system for automated longitudinal guidance of a motor vehicle, comprising:
a sensor system configured to identify an upcoming traffic scene, including locating road users situated ahead of the motor vehicle; and
a control unit configured to:
carry out an automated longitudinal guidance of the motor vehicle depending on the upcoming traffic scene such that, in response to detecting that the upcoming traffic scene is a following-travel standstill situation, the motor vehicle is braked to a standstill at a target stopping distance from a road user situated ahead and identified as a target object, and
detect a manual request to reduce the predefined target stopping distance, and
reduce the target stopping distance to a reduced target stopping distance on the basis of the request.

11. The driver assistance system of claim 10, wherein the control unit is configured to prompt the reduction in the target stopping distance to the reduced target stopping distance during the following-travel standstill situation, based on the reduced target stopping distance.

12. The driver assistance system of claim 10, wherein the control unit is configured to cancel the reduction in the target stopping distance when a predefined cancel condition is satisfied, wherein the predefined cancel condition includes: that the speed of the motor vehicle exceeds a predefined speed threshold.

13. The driver assistance system of claim 10, further comprising:
an operating element configured to be actuated so as to trigger the manual request to reduce the predefined target stopping distance during the following-travel standstill situation when the motor vehicle is at the standstill.

14. The driver assistance system of claim 13,
wherein the operating element is configured to request at least two different functionalities, and
wherein the control unit is configured to assign the manual request to one of the functionalities, depending on the time and/or type of the actuation.

15. The driver assistance system of claim 13,
wherein the operating element is configured to be actuated in at least two different types of actuation for manually requesting the reduction in the stopping distance,
wherein, upon manual actuation in accordance with a first type of actuation, during the following-travel standstill situation when the motor vehicle is at the standstill, the target stopping distance is reduced by a predefined reduction distance, and
wherein, upon manual actuation in accordance with a second type of actuation, during the following-travel standstill situation when the motor vehicle is at the standstill, the target stopping distance is continuously reduced over a duration of the actuation of the operating element in accordance with the second type of actuation.

16. The driver assistance system of claim 10, wherein an extent of the reduction in the target stopping distance is influenced by at least one of: a currently set driving mode, a road class of the road currently being traveled on, and an object class of the road user situated up ahead.

17. The driver assistance system of claim 10, wherein the predefined target stopping distance is reduced to the reduced target stopping distance based on the manual request to reduce the stopping distance, only when further requirements are met.

18. A method for automated longitudinal guidance of a motor vehicle, comprising the following steps:
identifying an upcoming traffic scene, including: locating road users situated ahead;
controlling an automated longitudinal guidance of the motor vehicle depending on the upcoming traffic scene, in response to identifying that the upcoming traffic scene is a following-travel standstill situation, the motor vehicle is braked to a standstill at a target stopping distance from a road user situated ahead and identified as a target object, detecting a manual request to reduce the stopping distance; and
reducing the target stopping distance to a reduced target stopping distance on the basis of the request.
